(19) United States
(12) Patent Application Publication
(10) Pub. No.: US 2013/0085475 A1
(43) Pub. Date: Apr. 4, 2013

(54) Medicated And Flavored Pacifier

(71) Applicants: Hermon McNac, III, Muskogee, OK (US); Hermon McNac, JR., Muskogee, OK (US)

(72) Inventors: Hermon McNac, III, Muskogee, OK (US); Hermon McNac, JR., Muskogee, OK (US)

(21) Appl. No.: 13/249,917

(22) Filed: Sep. 30, 2011

(51) Int. Cl. A61J 7/00; A61J 17/00

(52) U.S. Cl. 604/514; 604/77

(57) ABSTRACT

A pacifier for administering medicine comprising: a ring; a nipple, where the nipple connects to the ring; a shield surrounds the nipple, where the shield abuts a connecting ring; a threaded ring extending from the shield and connects to the connecting ring; an opening within the threaded ring for the insertion of liquid medicine; and a hole at the tip of the nipple that allows for the passage of the medicine from the nipple for administration to an infant user. In one exemplary embodiment, a flavoring covers the surface of the nipple. The nipple may hold a predetermined amount of medicine.

### BACKGROUND OF THE INVENTION

1. Field of Invention

The present invention relates to a pacifier that is capable of delivering medication and is flavored to enhance the delivery of the medication.

2. Description of Related Art

A pacifier is a rubber or a plastic nipple that is given to an infant to suck on as a means to comfort and pacify the child for a brief period of time. Most pacifiers include a nipple, a shield and a holding ring. The mouth shield is usually large enough to avoid the endangerment of choking and swallowing the nipple during use. The ring is used for the handling of the nipple by the parent and in certain occasions, the child. Pacifiers are utilized for a child during the day and at night. Since when a child uses a pacifier the infant normally has a propensity to suck on the pacifier. This sucking assists the child in soothing the child and also may be helpful during the teething period. Although there have been some studies that pacifiers may be harmful, pacifiers are still commonly used by parents and therefore also have been proven to be helpful in preventing SIDS in certain instances.

It would be helpful if the pacifier could be used to deliver medicine for the child in an effective manner and also help encourage the delivery of the medicine by being flavored.

### SUMMARY OF THE INVENTION

The present invention relates to a pacifier for administering medicine comprising: a ring; a nipple, where the nipple connects to the ring; a shield surrounds the nipple, where the shield abuts a connecting ring; a threaded ring extending from the shield and connects to the connecting ring; an opening within the threaded ring for the insertion of liquid medicine; and a hole at the tip of the nipple that allows for the passage of the medicine from the nipple for administration to an infant user. In one exemplary embodiment, a flavoring covers the surface of the nipple. The nipple may hold a predetermined amount of medicine.

### BRIEF DESCRIPTION OF DRAWINGS

FIG. 1 depicts a medicinal pacifier according to the present invention.

FIG. 2 depicts a prospective view of the components of the medicinal pacifier according to the present invention.

### DETAILED DESCRIPTION

The present invention relates to a pacifier that is capable of delivering medicine and includes a flavored nipple to induce the use of the pacifier by the infant. The pacifier according to present invention includes a means to insert medication within the nipple at a predetermined dosage and therefore allow the administering of the medicine while the infant enjoys sucking on the pacifier. The nipple of the pacifier according to present invention is flavored to enhance or diminish any unpleasant taste that may be associated with the medicine in the pacifier. The pacifier according to present invention includes a detachable nipple that allows for the insertion of the medicine within the nipple and then enables the user to reassemble the pacifier reattaching the holding ring and therefore allowing for the administration of up to a teaspoon of liquid medicine through the pacifier. The medicine is essentially self-administered by the infant through the use of the pacifier according to the present invention.

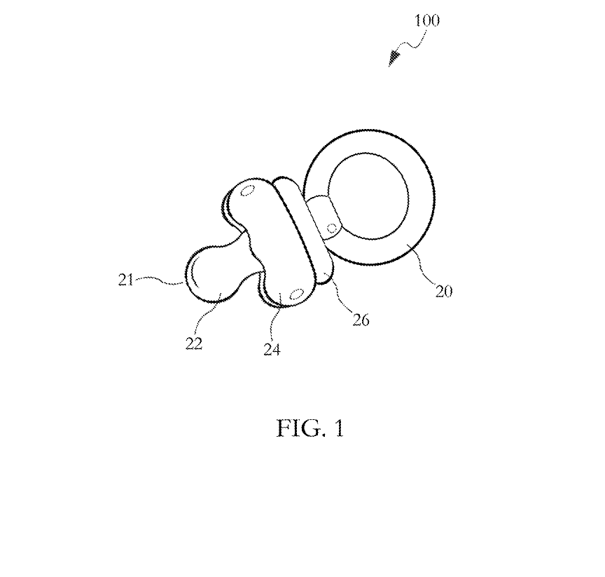

In reference to FIG. 1, a prospective view of a Pacifier 100 according to the present invention is depicted. The Pacifier 100 as shown in FIG. 1 includes a ring 20 that connects to the nipple 22. Surrounding the nipple 22 is a shield 24 that abuts a connecting ring 26. The Pacifier 100 as depicted in FIG. 1 is completely assembled and includes a hole 21 at the tip of the nipple 22 that allows for the passage of a medicine from the nipple for administration to an infant user.

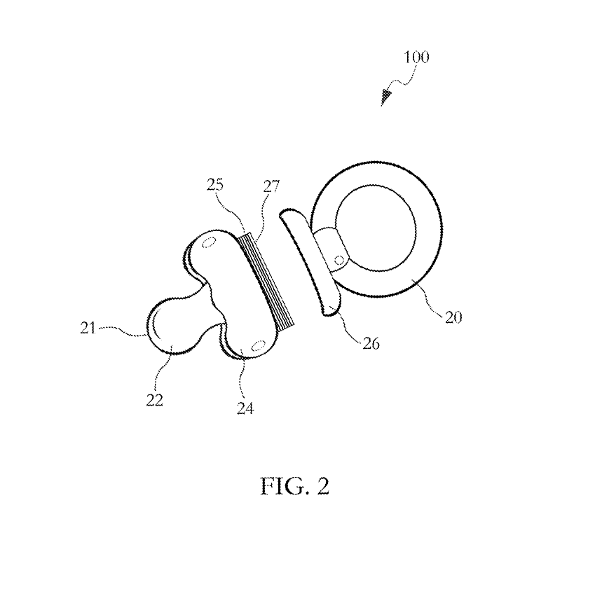

FIG. 2 depicts an exploded view of the Pacifier 100 components. As shown, ring 20 with the connecting ring 26 separates from the nipple assembly. Extending from the shield 24 of the nipple assembly is a threaded ring 25 that connects with the connecting ring 26 as shown. An opening 27 is provided that allows for the insertion of medicine within the inside of the nipple 22. After the appropriate level of medication is inserted within the nipple 22, the connecting ring 26 is screwed upon the threaded ring 25 and sealed for use. When in use, the infant upon sucking upon the nipple 22 receives a delivery of medicine through the hole 21 of the nipple 22.

In addition to providing a means for the insertion for medicine within the nipple 22, the outer surface of the nipple 22 is covered with a flavoring that enhances and appeals to an infant. The flavoring helps to mask the taste of the medicine and entices the infant to suck upon the nipple. The nipple, as with many nipples, may be made of latex, silicone, or plastic materials. The shaping of the nipple may be appropriate for the reception of the nipple into the child's mouth. Also, the interior of the nipple may be able to hold up to a tablespoon of liquids for administration through the nipple. The use of the pacifier according to the present invention helps to reduce spillage, gagging, or spitting up of the medicine due to the administration of the medicine through the nipple essentially at the child's own pace. Use of the present invention advantageously supplies a means for the administration of medicine and also for the comforting of the infant during the administration of the medicine.

What is claimed is:

1. A pacifier for administering medicine comprising:
a. a ring;
b. a nipple, where the nipple connects to the ring;
c. a shield surrounds the nipple, where the shield abuts a connecting ring;
d. a threaded ring extending from the shield and connects to the connecting ring;
e. an opening within the threaded ring for the insertion of liquid medicine; and
f. a hole at the tip of the nipple that allows for the passage of the medicine from the nipple for administration to an infant user.

2. The pacifier according to claim 1, where a flavoring covers the surface of the nipple.

3. The pacifier according to claim 1, where the nipple holds a predetermined amount of medicine.

4. A method of administering medicine to an infant comprising the steps of:
a. removing a nipple from a pacifier assembly;
b. inserting a dosage of medicine into the nipple;
c. reconnecting the nipple to the pacifier assembly;
d. covering the surface of the nipple with a flavor; and
e. serving the medicine filled pacifier assembly to the infant.
